(19) United States
(12) Patent Application Publication
(10) Pub. No.: US 2024/0201641 A1
(43) Pub. Date: Jun. 20, 2024

(54) METHODS FOR NOISE REDUCTION AT SMART GAS FIELD STATIONS, INTERNET OF THINGS SYSTEMS, AND STORAGE MEDIA THEREOF

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei ZHANG, Chengdu (CN); Zhubin CHENG, Chengdu (CN)

(73) Assignee: CHENGDU QINCHUAN IOT TECHNOLOGY CO., LTD., Chengdu (CN)

(21) Appl. No.: 18/592,451

(22) Filed: Feb. 29, 2024

(30) Foreign Application Priority Data
Nov. 10, 2023 (CN) 202311500215.5

(51) Int. Cl. G05B 13/02; G05D 16/20; G16Y 10/35

(52) U.S. Cl. CPC G05B 13/0205; G05D 16/20; G16Y 10/35

(57) ABSTRACT

Methods for noise reduction at a smart gas field station, Internet of Things (IoT) systems, and storage media are provided. The method may include obtaining relevant data of a target field station, the relevant data including at least one of operating data of the target field station, noise data of the target field station, and a pressure regulation parameter of an associated field station; predicting, based on the relevant data, noise enhancement data of the target field station for at least one future period; and determining a noise reduction control parameter based on the noise enhancement data and the pressure regulation parameter. The IoT system may include a smart gas user platform, a smart gas service platform, a smart gas safety management platform, a smart gas pipeline network equipment sensing network platform, and a smart gas pipeline network equipment object platform.

### CROSS-REFERENCE TO RELATED APPLICATIONS

This application claims priority to Chinese Application No. 202311500215.5, filed on Nov. 10, 2023, the entire contents of which are incorporated herein by reference.

### TECHNICAL FIELD

The present disclosure relates to the technical field of gas equipment, and in particular, to methods for noise reduction at smart gas field stations, Internet of Things systems, and storage media thereof.

### BACKGROUND

The noise sources in a gas field station mainly include mechanical noise, pneumatic noise, and electromagnetic noise. Noise may have serious impacts, such as health hazards, including various types of neurological and psychiatric damage, on personnel working in the gas field station and the surrounding environment. With the increasing number of users and the gradual increase in natural gas consumption, the gas field station is facing more frequent high-load operations, and the noise issues in the gas field station are becoming more prominent. Therefore, there is currently an urgent need for all gas companies to solve these problems effectively. However, noise-reducing components such as noise-reducing tubes or soundproof panels often have a limited service life and are less effective in reducing noise. The active imposition of noise reduction signals tends to be limited and lagging, not allowing for timely warnings and adjustments when the noise changes, which may damage the health of personnel.

Therefore, it is desired to provide a method for noise reduction at a smart gas field station, an Internet of Things (IoT) system, and a storage medium, to predict noise changes at the gas field station, and to implement timely adjustments and warnings, thereby reducing damage to the health of personnel.

### SUMMARY

One of the embodiments of the present disclosure provides a method for noise reduction at a smart gas field station. The method may include obtaining relevant data of a target field station. The relevant data may include at least one of operating data of the target field station, noise data of the target field station, and a pressure regulation parameter of an associated field station, and the associated field station is a gas field station in a gas pipeline network that jointly regulates pressure with the target field station. The method may also include predicting, based on the relevant data, noise enhancement data of the target field station for at least one future period. The method may further include determining, in response to the noise enhancement data satisfying a predetermined condition, a noise reduction control parameter based on the noise enhancement data and the pressure regulation parameter. The noise reduction control parameter may include at least a pressure regulation update parameter of the target field station or the associated field station for the at least one future period.

One of the embodiments of the present disclosure provides an Internet of Things (IoT) system for noise reduction at a smart gas field station, and the system may include a smart gas user platform, a smart gas service platform, a smart gas safety management platform, a smart gas pipeline network equipment sensing network platform, and a smart gas pipeline network equipment object platform. The smart gas safety management platform may include a smart gas pipeline network safety management sub-platform and a smart gas data center. The smart gas pipeline network equipment sensing network platform may be configured to interact with the smart gas data center and the smart gas pipeline network equipment object platform. The smart gas safety management platform may be configured to obtain relevant data of a target field station. The relevant data may include at least one of operating data of the target field station, noise data of the target field station, and pressure regulation parameter of an associated field station, and the associated field station is a gas field station in a gas pipeline network that jointly regulates pressure with the target field station. The smart gas safety management platform may also be configured to predict, based on the relevant data, noise enhancement data of the target field station for at least one future period. The smart gas safety management platform may further be configured to determine, in response to the noise enhancement data satisfying a predetermined condition, a noise reduction control parameter based on the noise enhancement data and the pressure regulation parameter. The noise reduction control parameter may include at least a pressure regulation update parameter of the target field station or the associated field station for the at least one future period. The smart gas service platform may be configured to send the noise reduction control parameter to the smart gas user platform.

One of the embodiments of the present disclosure provides a non-transitory computer-readable storage medium storing computer instructions. When reading the computer instructions in the storage medium, a computer implements the method for noise reduction at the smart gas field station.

### BRIEF DESCRIPTION OF THE DRAWINGS

The present disclosure is further illustrated in terms of exemplary embodiments. These exemplary embodiments are described in detail according to the drawings. These embodiments are non-limiting examples, in which like reference numerals represent similar structures, wherein:

FIG. 1 is a schematic diagram illustrating an exemplary platform structure of an Internet of Things (IoT) system for noise reduction at a smart gas field station according to some embodiments of the present disclosure;

FIG. 2 is a flowchart illustrating an exemplary process of a method for noise reduction at a smart gas field station according to some embodiments of the present disclosure;

FIG. 3 is an exemplary schematic diagram illustrating predicting the noise enhancement data through a first prediction model according to some embodiments of the present disclosure;

FIG. 4 is a flowchart illustrating an exemplary process of determining a noise reduction control parameter according to some embodiments of the present disclosure; and

FIG. 5 is an exemplary schematic diagram illustrating determining predicted enhancement data through a second prediction model according to some embodiments of the present disclosure.

### DETAILED DESCRIPTION

To more clearly illustrate the technical solutions related to the embodiments of the present disclosure, a brief introduction of the drawings referred to in the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless it is obviously obtained from the context or the context clearly indicates otherwise, the same numeral in the drawings refers to the same structure or operation.

As shown in the present disclosure and claims, unless the context clearly dictates otherwise, the words “a”, “an”, “one” and/or “the” are not intended to be specific in the singular and may include the plural. In general, the terms “comprise,” “comprises,” “comprising,” “include,” “includes,” and/or “including,” merely prompt to include operations and elements that have been clearly identified, and these operations and elements do not constitute an exclusive listing. The methods or devices may also include other operations or elements.

The flowcharts used in the present disclosure illustrate operations performed by systems according to some embodiments of the present disclosure. It should be understood that the preceding or subsequent operations may not be executed in a precise order. Instead, the steps may be carried out in reverse order or simultaneously. Meanwhile, other operations may also be added to these processes, or a certain step or several steps may be removed from these processes.

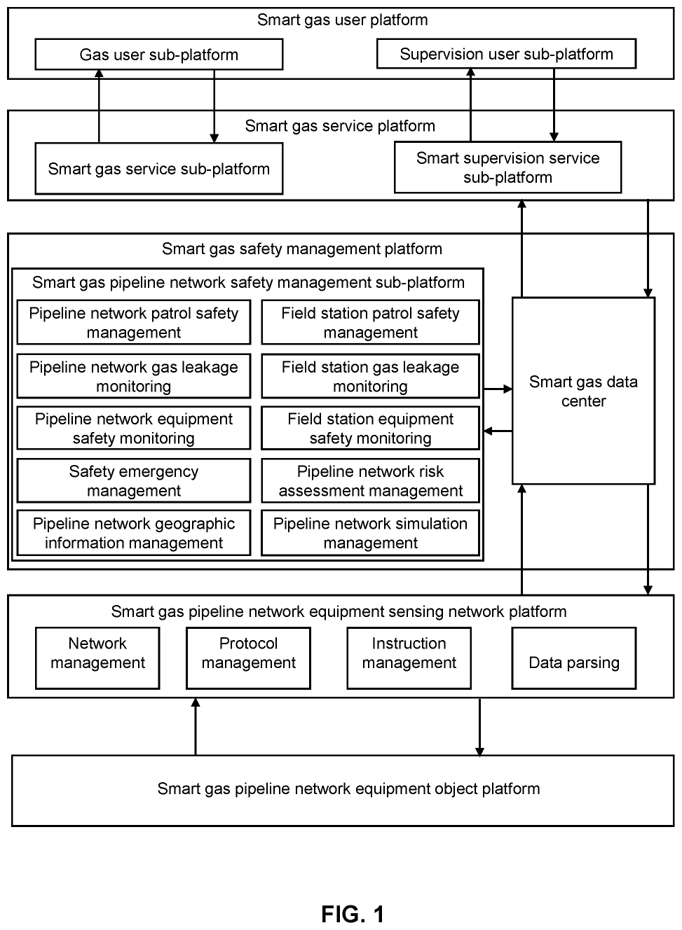

FIG. 1 is a schematic diagram illustrating an exemplary platform structure of an Internet of Things (IoT) system for noise reduction at a smart gas field station according to some embodiments of the present disclosure. It should be noted that the following embodiments are only used to explain the present disclosure and do not limit the present disclosure.

As shown in FIG. 1, the IoT system for noise reduction at the smart gas field station includes a smart gas user platform, a smart gas service platform, a smart gas safety management platform, a smart gas pipeline network equipment sensing network platform, and a smart gas pipeline network equipment object platform interacting with each other. In some embodiments, the IoT system for noise reduction at the smart gas field station may be a part of a processing device or may be implemented by the processing device.

The smart gas user platform refers to a platform used for interacting with users. In some embodiments, the smart gas user platform may be configured as a terminal device.

In some embodiments, the smart gas user platform may include a gas user sub-platform and a supervision user sub-platform. The gas user sub-platform may be used for interacting with gas users. The supervision user sub-platform may be used for interacting with supervision users (e.g., relevant persons and/or authorities related to ensuring gas safety).

The smart gas service platform may be a platform for receiving and transmitting data and/or information. For example, the smart gas service platform may receive instructions sent by the smart gas user platform and send the instructions to the smart gas safety management platform after processing. As another example, the smart gas service platform may obtain information required by the user from the smart gas safety management platform and send the information to the smart gas user platform. In some embodiments, the smart gas service platform may be configured to send a noise reduction control parameter to the smart gas user platform.

In some embodiments, the smart gas service platform may include a smart gas service sub-platform and a smart supervision service sub-platform.

In some embodiments, the smart gas service sub-platform may interact with the gas user sub-platform in correspondence, and the smart supervision service sub-platform may interact with the supervision user sub-platform in correspondence.

The smart gas safety management platform may be a platform that provides a sensing management function and a control management function for the IoT system for noise reduction at the smart gas field station. The smart gas safety management platform may coordinate and deploy the connection and collaboration between various functional platforms and converge all the information of the IoT system for noise reduction at the smart gas field station.

In some embodiments, the smart gas safety management platform may include a smart gas data center and a smart gas pipeline network safety management sub-platform.

The smart gas data center may aggregate and store all the operating data of the IoT system for noise reduction at the smart gas field station. The smart gas safety management platform may exchange information with the smart gas service platform and the smart gas pipeline equipment sensing network platform through the smart gas data center.

The smart gas pipeline network safety management sub-platform may be a separate data usage platform. The smart gas pipeline network safety management sub-platform may obtain relevant data from the smart gas data center and send operating data to the smart gas data center. In some embodiments, the smart gas pipeline network safety management sub-platform may include functions such as pipeline network patrol safety management, pipeline network gas leakage monitoring, pipeline network equipment safety monitoring, safety emergency management, pipeline network geographic information management, field station patrol safety management, field station gas leakage monitoring, field station equipment safety monitoring, pipeline network risk assessment management, pipeline network simulation management, etc.

For example, the smart gas data center may receive a query instruction for operational management information of a gas gate station issued by the smart gas service platform. The smart gas data center may issue instructions to obtain relevant data of gas equipment (e.g., gas flow and gas pressure) to the smart gas pipeline equipment sensing network platform or receive the relevant data of gas equipment uploaded by the smart gas pipeline equipment sensing network platform. The smart gas data center sends the relevant data of gas equipment to the smart gas pipeline network safety management sub-platform for analysis and processing.

The smart gas pipeline network equipment sensing network platform refers to a functional platform for managing sensing communication. In some embodiments, the smart gas pipeline network equipment sensing network platform may be configured as a communication network and a gateway. The smart gas pipeline network equipment sensing network platform may receive relevant data uploaded by the object platform and issue instructions to the smart gas pipeline network equipment object platform to obtain the relevant data. Alternatively, the smart gas pipeline network equipment sensing network platform may receive instructions from the smart gas data center to obtain relevant data and upload the relevant data to the smart gas data center. In some embodiments, the smart gas pipeline network equipment sensing network platform may be configured to interact with the smart gas data center and the smart gas pipeline network equipment object platform.

In some embodiments, the smart gas pipeline network equipment sensing network platform may implement one or more functions such as network management, protocol management, instruction management, and data parsing.

The smart gas pipeline network equipment object platform refers to a functional platform for generating sensing information. The smart gas pipeline network equipment object platform may be configured as various types of gas-related equipment. The gas-related equipment may include pipeline network equipment. The pipeline network equipment may include a gas gate station, sections of gas pipelines, gas valve control equipment, gas meters, flow meters, pressure gauges, noise collection equipment, pressure regulation equipment, temperature sensors, humidity sensors, etc. The information that may be obtained by the smart gas pipeline network equipment object platform may include but is not limited to, gas flow information, gas pressure information, etc. The smart gas pipeline network equipment object platform may transmit the collected information to the smart gas safety management platform through the smart gas pipeline network equipment sensing network platform.

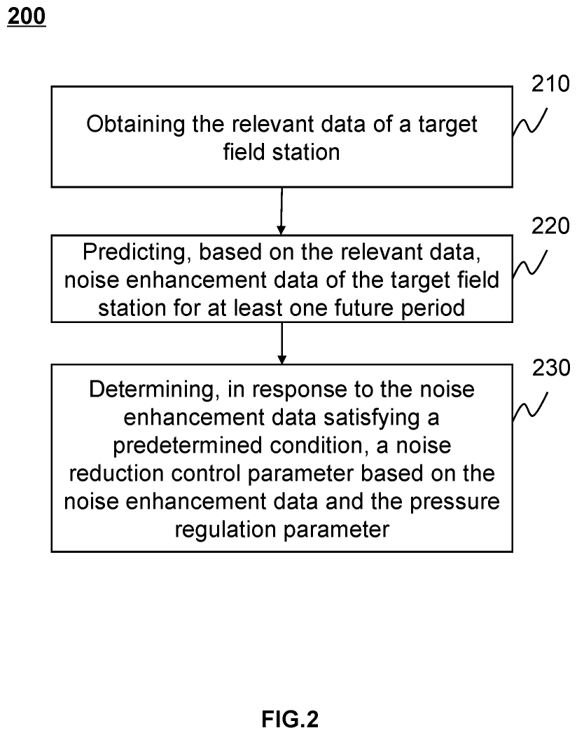

Further description regarding the above may be found in FIG. 2 to FIG. 5 and the related description thereof.

The IoT system for noise reduction at the smart gas field station may form a closed loop of information operation between the smart gas pipeline network equipment object platform and the smart gas user platform. It operates regularly under the unified management of the smart gas safety management platform to achieve the informatization and intelligentization of noise reduction at gas field stations.

FIG. 2 is a flowchart illustrating an exemplary process of a method for noise reduction at a smart gas field station according to some embodiments of the present disclosure. In some embodiments, a process 200 may be performed by the smart gas safety management platform. As shown in FIG. 2, process 200 includes the following steps.

In step 210, obtaining the relevant data of a target field station.

The target field station refers to a gas field station that requires noise reduction processing.

The relevant data refers to data involved in the noise reduction processing of the target field station. In some embodiments, the relevant data may include at least one of the operating data of the target field station, the noise data of the target field station, and the pressure regulation parameter of an associated field station.

The operating data refers to data related to gas transportation at the target field station. For example, the operating data may include gas flow and gas pressure of different gas pipelines input by the target field station. In some embodiments, the smart gas safety management platform may obtain the operating data from a smart gas pipeline network equipment object platform based on the smart gas pipeline network equipment sensing network platform, and transmit the operating data to the smart gas data center in the smart gas safety management platform.

The noise data refers to relevant data related to the noise of the target field station during operation. In some embodiments, the noise data may include basic noise data and historical noise enhancement data. The historical noise enhancement data refers to noise enhancement data of the target field station during different periods within a certain period of time in the past. In some embodiments, the smart gas safety management platform may filter out the basic noise data from the obtained noise data to determine the historical noise enhancement data. Further descriptions regarding the noise enhancement data may be found in step 220 and the related descriptions thereof.

In some embodiments, the smart gas safety management platform may obtain the noise data from the smart gas pipeline network equipment object platform based on a smart gas pipeline network equipment sensing network platform, and transmit the noise data to the smart gas data center in the smart gas safety management platform.

The associated field station refers to a gas field station in a gas pipeline network that jointly regulates pressure with the target field station. There may be a plurality of associated field stations and a plurality of target field stations within the same gas pipeline network. Collaborative interactions may occur between a plurality of associated field stations and a plurality of target field stations. The collaborative interactions can implement a plurality of functions, including pressure balance and adjustment, fault handling, gas quality assurance, flexibility, monitoring, communication of gas supply, etc., thereby ensuring the stability and safety of the entire gas pipeline network, optimizing gas supply, and meeting users' gas demand.

The pressure regulation parameter refers to a relevant parameter of the associated field station during the pressure regulation process. For example, the pressure regulation parameter may include pressure regulation time, pressure regulation load data, and a pipeline where pressure regulation takes place in a plan. The pressure regulation load data refers to a pressure difference before and after pressure regulation at the field station. The plan refers to the relevant plan for pressure regulation at the field station for at least one future period.

The smart gas safety management platform may access the pressure regulation parameter in a plurality of ways. For example, the smart gas safety management platform may directly obtain the pre-stored pressure regulation parameter from the IoT system for noise reduction at the smart gas field station. In some embodiments, the smart gas safety management platform may obtain the pressure regulation parameter from the smart gas pipeline network equipment object platform based on the smart gas pipeline network equipment sensing network platform and transmit the pressure regulation parameter to the smart gas data center in the smart gas safety management platform. In some embodiments, the smart gas safety management platform may directly retrieve the pressure regulation parameter from the smart gas data center based on a smart gas pipeline network safety management sub-platform.

In step 220, predicting, based on the relevant data, noise enhancement data of the target field station for at least one future period.

The at least one future period refers to at least one period in the future. In some embodiments, the smart gas safety management platform may select a period during which people are more sensitive to noise as at least one future period (e.g., lunch break, after-work hours, etc.). In some embodiments, the smart gas safety management platform may select a period during which the basic noise data is as large as at least one future period (e.g., a period during which the noise is very close to a noise limit). The noise limit refers to the maximum value of the noise at the target field station set by relevant regulations.

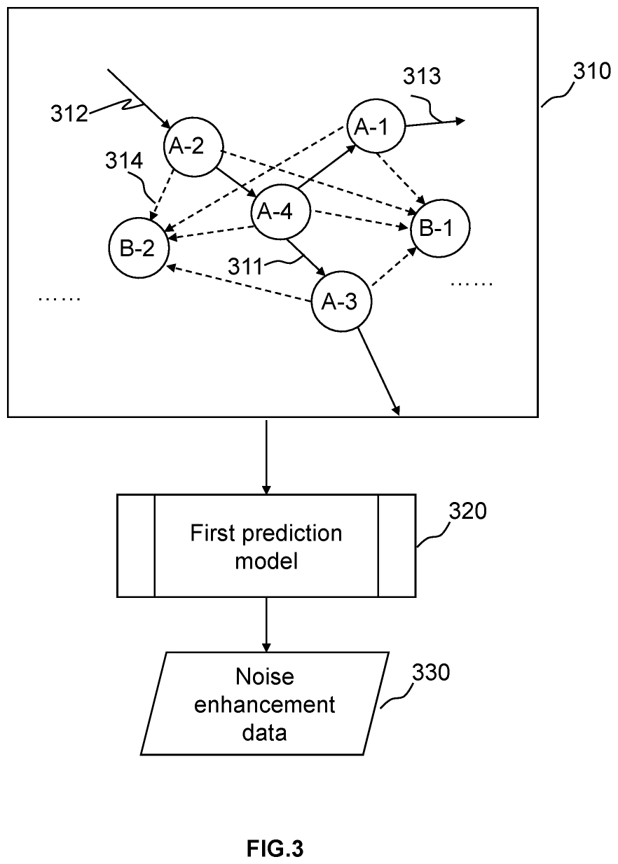

The noise enhancement data refers to data with increased noise on the basis of the basic noise data. For example, the noise enhancement data may include increments of parameters such as sound frequency, intensity, etc., over the basic noise data. The noise enhancement data may be the noise enhancement data detected for the entire target field station, or may specifically be the noise enhancement data detected at a plurality of interest points of the gas field station. More detailed descriptions regarding the interest point may be found in FIG. 3 and related descriptions thereof.

The smart gas safety management platform may predict the noise enhancement data for at least one future period in a plurality of ways. In some embodiments, the smart gas safety management platform may construct a query feature vector based on the operating data of the target field station, the basic noise data, and the pressure regulation parameter of the associated field station and determine the noise enhancement data by matching the vectors in a first vector database. The first vector database contains a plurality of historical vectors composed of historical operating data, historical noise data, a historical pressure regulation parameter of the associated field station, and historical noise enhancement data corresponding to the historical vectors. In some embodiments, the smart gas safety management platform may determine the historical vectors in the first vector database that meet vector preconditions based on the query feature vector. The smart gas safety management platform may determine a reference vector that meets the vector preconditions and determine the historical noise enhancement data corresponding to the reference vector as the noise enhancement data for at least one future period. The vector preconditions refer to judgment conditions used to determine the historical vectors. In some embodiments, the vector preconditions may include a vector distance being less than a distance threshold, a vector distance being minimized, or the like.

In some embodiments, the smart gas safety management platform may determine, based on the pressure regulation parameter of the associated field station, the pressure regulation load data of the target field station for at least one future period; and predict, based on the relevant data and the pressure regulation load data, the noise enhancement data of the target field station for at least one future period.

The smart gas safety management platform may determine the pressure regulation load data of the target field station for at least one future period in a plurality of ways. In some embodiments, the smart gas safety management platform may determine the gas pressure output from the upstream associated field station based on the pressure regulation parameters of the associated field station, and use a difference between the gas pressure output from the upstream associated field station and a target gas pressure of each pressure regulation device of the target field station as the pressure regulation load data. The target gas pressure refers to the gas pressure that needs to be output from the target field station. The upstream associated field station of the pressure regulation device refers to a gas field station in the gas pipeline network that is located upstream of the target field station. In some embodiments, the smart gas safety management platform may obtain a pre-specified gas pressure output from an upstream associated field station and a target gas pressure from the smart gas pipeline network equipment object platform based on the smart gas pipeline network equipment sensing network platform.

In some embodiments, the smart gas safety management platform may assess a usage impact value of gas usage on the gas pressure based on gas usage data of upstream and downstream of the target field station. The smart gas safety management platform determines a pre-regulation pressure and a target pressure of the target field station based on the usage impact value and the pressure regulation parameter of the associated field station. The smart gas safety management platform may determine the pressure regulation load data of the target field station for at least one future period based on the pre-regulation pressure and the target pressure.

The gas usage data of upstream and downstream of the target field station refers to relevant data on gas usage of gas equipment between the associated field station for gas input and output of the target field station and the target field station. The gas usage data of upstream and downstream of the target field station includes upstream gas usage data and downstream gas usage data of the target field station. The upstream gas usage data refers to the relevant data of gas usage by the gas equipment between the associated field station of upstream of the target field station and the target field station. The downstream gas usage data refers to the relevant data of gas usage by the gas equipment between the associated field station of downstream of the target field station and the target field station. In some embodiments, the smart gas safety management platform may obtain the gas usage data of upstream and downstream from the smart gas pipeline network equipment object platform based on the smart gas pipeline network equipment sensing network platform.

The usage impact value refers to a value of the change in the gas pressure caused by the use of gas. The usage impact value includes gas usage data of upstream and gas usage data of downstream. After gas usage, the amount of gas in the gas pipeline decreases, and the gas pressure output from the upstream associated field station naturally decreases, resulting in the gas pressure input from the target field station being actually lower than the gas pressure output from the upstream associated field station.

In some embodiments, the smart gas safety management platform may determine an amount of gas consumption in the gas pipeline by replacing gas usage data for future periods with gas usage data of the upstream and downstream for the same period. The smart gas safety management platform may determine, based on the amount of gas consumption, the amount of gas pressure reduction in the gas pipeline as the usage impact value. In some embodiments, the smart gas safety management platform may collect and count pressure values of the gas before and after passing through a household pipeline through the flow meter and pressure gauge in the gas pipeline network. The smart gas safety management platform may correlate historical gas usage data corresponding to the household pipeline and a difference between the pressure values before and after the historical gas passes through the household pipeline to create a preset table. After obtaining the amount of gas consumption, the smart gas safety management platform may obtain the amount of gas pressure reduction in the gas pipeline by referring to the preset table.

The pre-regulation pressure refers to the gas pressure at the target field station before regulation for at least one future period. In some embodiments, the smart gas safety management platform may take a result obtained by subtracting the upstream usage impact value from the gas pressure output from the upstream associated field station as the pre-regulation pressure of the target field station. In some embodiments, the gas pressure output from the upstream associated field station may be obtained in a pre-set manner.

The target pressure refers to a regulated gas pressure at the target field station for at least one future time period. In some embodiments, the smart gas safety management platform may determine the target pressure by adding the gas pressure required by a downstream gas pipeline and the usage impact value of downstream. In some embodiments, the smart gas safety management platform may determine the target pressure by adding the gas pressure required by the downstream gas pipeline and half of the result obtained from the impact value of downstream usage. This allows the pressure in the downstream pipeline to fluctuate within the required gas pressure range. In some embodiments, the amount of the downstream usage impact value added to the gas pressure required by the downstream gas pipeline may be determined based on actual needs. In some embodiments, the gas pressure required by the downstream gas pipeline may be obtained in a pre-set manner.

In some embodiments, the smart gas safety management platform may use the difference between the pre-regulation pressure and the target pressure of the target field station for the future period as the pressure regulation load data of the target field station for the future period.

Some embodiments of the present disclosure indirectly determine the pressure regulation load data of the target field station for the future time period based on the usage impact value determined from the gas usage data of upstream and downstream, allowing for more accurate prediction of pressure regulation load data and providing a solid foundation for subsequent prediction of noise enhancement data.

In some embodiments, the smart gas safety management platform may construct a problem feature vector based on the pressure regulation load data of the target field station, the basic noise data, and the pressure regulation parameter of the associated field station and determine the noise enhancement data by vector matching based on a second vector database. More descriptions regarding vector matching may be found hereinabove. The second vector database may contain pressure regulation load data and historical noise data of a plurality of historical target field stations, a historical vector including a pressure regulation parameter of a historical associated field station, and historical noise enhancement data for at least one period corresponding to the historical vector. In some embodiments, the smart gas safety management platform may determine, based on the problem feature vector, the historical vector satisfying the vector preconditions are determined to be a compliant vector in the second vector database, and the historical noise enhancement data corresponding to at least one period of the compliant vector is determined to be noise enhancement data.

In some embodiments, the smart gas safety management platform may determine the noise enhancement data of a target field station for at least one future period by the first prediction model. More descriptions may be found in FIG. 3 and the related descriptions thereof.

In some embodiments of the present disclosure, by considering both the relevant data and the pressure regulation load data, the noise enhancement data of the target field station for the future period may be more accurately predicted, which helps improve the accuracy of subsequently determined noise reduction control parameters.

In step 230, determining, in response to the noise enhancement data satisfying a predetermined condition, a noise reduction control parameter based on the noise enhancement data and the pressure regulation parameter.

The predetermined condition refers to a condition that needs to be met for noise reduction. For example, the predetermined condition may be that the noise enhancement data exceeds a maximum threshold. The maximum threshold is a gap between the noise limit at the target field station and the basic noise data. In some embodiments, the predetermined condition may be determined based on a priori knowledge. More detailed descriptions regarding the noise limit may be found in step 220 and related descriptions thereof.

The noise reduction control parameter refers to a relevant parameter that is adjusted for noise reduction. In some embodiments, the noise reduction control parameter may include at least a pressure regulation update parameter of the target field station and/or the associated field station for at least one future period.

The pressure regulation update parameter refers to an updated pressure regulation parameter.

In some embodiments, the smart gas safety management platform may determine the noise reduction control parameter in a variety of ways. For example, the smart gas safety management platform may appropriately reduce the pressure regulation parameter of the target field station based on the noise enhancement data, which makes the noise enhancement data of the target field station lower.

The smart gas safety management platform may determine an associated field station corresponding to gas pipelines with lower gas flow and the gas pressure based on the operating data of the target field station. Further, the smart gas safety management platform may increase the pressure regulation parameter of the associated field station to meet the gas pressure of the gas supply demand.

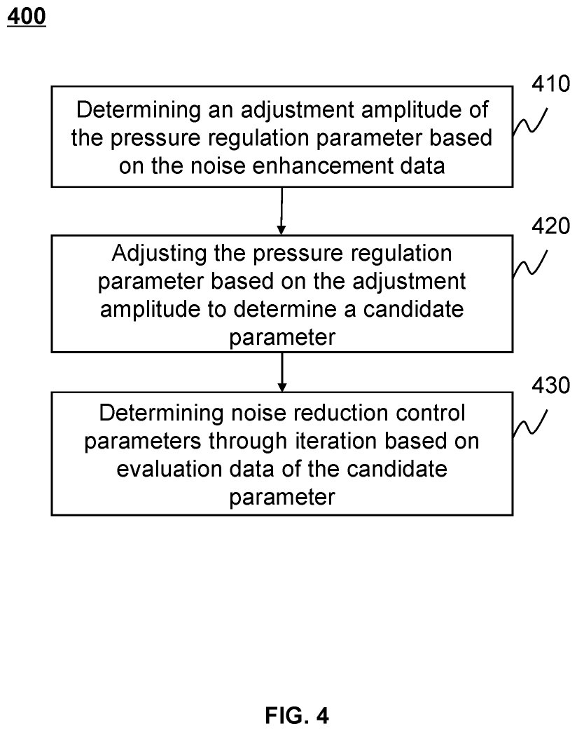

In some embodiments, the noise reduction control parameter may be determined based on the candidate parameters, and more details may be found in FIG. 4 and related descriptions thereof.

In some embodiments of the present disclosure, the present disclosure predicts the noise enhancement data for the future period based on the relevant data of the target field station and determines the noise reduction control parameters. It may personalize the control of the noise changes of the target field station, adjust the pressure regulation parameters in real-time and promptly, ensure that the noise level meets the requirements, and reduce the damage of the noise to personnel health.

It should be noted that the above description of the process is provided as an example and for illustration purposes only, and does not limit the scope of the present disclosure. For those skilled in the art, various modifications and changes to the process may be made under the guidance of the present disclosure. However, these modifications and changes are still within the scope of the present disclosure.

FIG. 3 is an exemplary schematic diagram illustrating predicting noise enhancement data through a first prediction model according to some embodiments of the present disclosure.

In some embodiments, as shown in FIG. 3, a smart gas safety management platform may predict noise enhancement data 330 of a target field station for at least one future period based on a field station sub-graph of the target field station 310 through a first prediction model 320, which is a machine learning model. More details regarding the noise enhancement data of the target field station for at least one future period may be found in the relevant description of FIG. 2.

The field station sub-graph of the target field station 310 refers to a directed graph for representing an association relationship between the pressure regulation device and the interest point within the target field station. The field station sub-graph of the target field station 310 may contain information about a plurality of pressure regulation devices in the target field station and corresponding pipeline, interest points, and other features. On the one hand, the field station sub-graph of the target field station of the target field station may reflect the noise superposition between a plurality of regulators and a plurality of interest points, on the other hand, the field station sub-graph of the target field station may supplement the noise data generated by gas transmission in a pipeline, making the predicted noise enhancement data more complete.

Noise generated at different locations has different impacts on the surrounding environment. At least one interest point refers to at least one location where the noise to be focused on is located. For example, a location towards the side of a dense population has a high noise impact, and the smart gas safety management platform may set the location as the interest point. In some embodiments, the smart gas safety management platform may determine a count and a location of the interest point based on actual needs.

The field station sub-graph of the target field station 310 may include nodes and edges.

In some embodiments, the nodes may include pressure regulation devices within the target field station (e.g., the pressure regulation devices A-1, A-2, A-3, A-4, etc. within the target field station A shown in FIG. 3), and at least one interest point within the target field station (e.g., points of concern B-1, B-2, etc. within the target field station A shown in FIG. 3).

In some embodiments, nodal features of the pressure regulation devices may include pressure regulation parameters, operating data, noise limits, pressure regulation load data, basic noise data, or the like. More detailed descriptions regarding the pressure regulation parameters, the operating data, the noise limits, the pressure regulation load data, and the basic noise data may be found in FIG. 2 and related descriptions thereof.

In some embodiments, nodal features of the interest point may include a point location.

In some embodiments, the edges may be directed edges. The edges may include a first class of edges and a second class of edges. In some embodiments, the first class of edges may include gas pipelines between any nodes, and a direction of the first class of edges indicates a gas flow direction within the gas pipelines. In some embodiments, the first class of edges may include internal edges within the target field station (e.g., edge 311, etc.) and external edges (e.g., edge 312 and edge 313) that are connected to other associated field stations, i.e., edges in afield station regulator graph. In some embodiments, features of the first class of edges may include pipe parameters (e.g., pipe material, pipe diameter, pipe length, impurities remaining in the pipe, etc.). In some embodiments, the second class of edges may include a direction of noise propagation between any nodes (e.g., edge 314, etc.). The features of the second class of edges may include a relative positional relationship between each pressure regulation device and the interest point (e.g., distance, direction, etc. between each pressure regulation device and the interest point).

In some embodiments, the smart gas service platform may construct a field station sub-graph of the target field station 310 based on data related to the pressure regulation device and/or at least one interest point at the target field station.

The first prediction model 320 refers to a model for determining the noise enhancement data. The first prediction model 320 may be a machine learning model (e.g., any one or a combination of structures from neural networks (NN), graph neural networks (GNN), etc.).

In some embodiments, an input of the first prediction model 320 may include the field station sub-graph of the target field station 310. An output of the first prediction model 320 may be the noise enhancement data 330 of the target field station for at least one future period. A node in the first prediction model outputs the noise enhancement data for at least one future period corresponding to at least one interest point.

In some embodiments, the first prediction model may be obtained by training based on a plurality of first training samples with first labels. The plurality of first training samples with the first labels may be input into an initial first prediction model, a loss function may be constructed from the first labels and results of the initial first prediction model, and the parameters of the initial first prediction model may be iteratively updated based on the loss function. When a loss function of the initial first prediction model satisfies preconditions, the model training is completed and a trained first prediction model is obtained. The preconditions may be that the loss function converges, a count of iterations reaches a threshold, etc.

In some embodiments, the first training samples may be historical field station sub-graphs of the target field station constructed based on the historical data of the first period, and the first label may be actual noise enhancement data for different interest points in the historical data of the second period. The first period precedes the second period, and the second period is the future period of the first period. In some embodiments, the first training sample may be obtained based on historical data. The first labels of the first training sample may be obtained by manual labeling.

Using the field station sub-graph of the target field station as the input of the first prediction model may reflect the superposition of noise between a plurality of pressure regulation devices. It may also supplement the noise data due to the gas transmission in the pipeline, making the predicted noise enhancement data more accurate and complete.

FIG. 4 is a flowchart illustrating an exemplary process of determining a noise reduction control parameter according to some embodiments of the present disclosure. As shown in FIG. 4, a process 400 includes the following steps. In some embodiments, the process 400 may be performed by the smart gas safety management platform.

In step 410, determining an adjustment amplitude of the pressure regulation parameter based on the noise enhancement data.

The adjustment amplitude refers to the magnitude of the adjustment of the pressure regulation parameter. In some embodiments, the adjustment amplitude includes the adjustment amplitude of each associated field station. In some embodiments, the smart gas safety management platform may determine the adjustment amplitude in a plurality of ways. In some embodiments, the smart gas safety management platform may determine the adjustment amplitude of the pressure regulation parameter of the target field station for at least one future period based on the noise enhancement data (e.g., the noise data at the target field station is regulated below the noise limit). The smart gas safety management platform may determine a total regulation load that needs to be shared by at least one associated field station according to the adjustment amplitude of the pressure regulation parameters of the target field station, to ensure that the gas pressure in the gas pipeline network may meet a gas supply demand. The smart gas safety management platform may distribute the total regulating load to be shared equally to at least one associated field station, thus determining the adjustment amplitude of the pressure regulation parameters for each associated field station. More detailed descriptions regarding the noise limit may be found in FIG. 2 and related descriptions thereof.

In some embodiments, the smart gas safety management platform may determine the adjustment amplitude of the associated field station based on a noise tolerance and associated enhancement data of the associated field station. In some embodiments, the lower the noise tolerance, the smaller the adjustment amplitude of the associated field station to minimize the possibility of excessive noise at the associated field station.

The noise tolerance refers to a maximum noise that may be tolerated by the associated field station. In some embodiments, the noise tolerance may be determined based on population distribution information around the associated field station and weather information for a day. On sunny days, noise propagation is good and noise tolerance is low; on days of bad weather (e.g., rainy days), sound of rain interferes with noise propagation and noise tolerance is high. When the associated field station is closer, noise volume attenuation is smaller and the noise tolerance is lower, conversely, when the associated field station is further away, the noise volume attenuation is larger and the noise tolerance is higher. In some embodiments, the smart gas safety management platform may determine a plurality of interest points with more population based on population distribution information, collect noise collection data from a plurality of interest points around the associated field station under different weather conditions using noise collection equipment. Then, the smart gas safety management platform may filter the noise collection data, e.g., other sound waves (e.g., rain, human voices, etc.) being filtered, to obtain regulating noise data, and determine the noise tolerance based on the magnitude of the regulating noise data.

The associated enhancement data refers to the noise enhancement data of the associated field station. In some embodiments, the smart gas safety management platform may determine the associated enhancement data for a historical concurrent period as the associated enhancement data for a corresponding future period.

In some embodiments, the smart gas safety management platform may determine an adjustment amplitude of the at least one associated field station based on the total regulating load to be shared by the at least one associated field station and by proportionally allocating the total regulating load based on the difference between the noise tolerance and the associated enhancement data for each associated field station. For example, the adjustment amplitude for each associated field station is positively correlated with the difference between the noise tolerance of the associated field station and the associated enhancement data.

In some embodiments of the present disclosure, the adjustment amplitude of at least one associated field station may be determined based on the noise tolerance and associated enhancement data, which allows for a better consideration of the acceptance of noise by different associated field stations and the impact of environmental factors on noise. As a result, the adjustment amplitude of the pressure regulation parameter of the associated field station may be more accurately determined, thereby improving the precision and adaptability of the regulating control.

In step 420, adjusting the pressure regulation parameter based on the adjustment amplitude to determine a candidate parameter.

The candidate parameter refers to a parameter that is to be identified as a pressure regulation update parameter. In some embodiments, the smart gas safety management platform may adjust the pressure regulation parameter of the target field station and/or the at least one associated field station based on the above-determined adjustment amplitude of the target field station and/or the at least one associated field station, respectively, to obtain a set of candidate pressure regulation update parameters of the target field station and/or the at least one associated field station as the candidate parameter. The candidate pressure regulation update parameters refer to data that is to be identified as the pressure regulation update parameters.

In step 430, determining noise reduction control parameters through iteration based on evaluation data of the candidate parameter.

The evaluation data refers to a score used to evaluate the candidate parameters. The greater the adjustment level of the pressure regulation parameters at the target field station and/or the at least one associated field station, the greater the potential unknown risks (such as increased noise, insufficient gas supply pressure, etc.), and the lower the evaluation data. In some embodiments, the evaluation data may be negatively correlated to a sum of a percentage of the adjustment amplitude of the target field station relative to original pressure regulation parameters, and a sum of a percentage of the adjustment amplitude of at least one associated field station relative to original pressure regulation parameters.

In some embodiments, the smart gas safety management platform may determine predicted enhancement data of the target field station and the associated field station based on the candidate parameter and determine the evaluation data for the candidate parameter based on the predicted enhancement data.

The predicted enhancement data refers to the noise enhancement data predicted based on the candidate parameter. In some embodiments, the smart gas safety management platform may determine the field station sub-graph of the corresponding associated field station based on information such as the candidate parameter, etc., and determine the predicted enhancement data for the candidate parameter corresponding to the associated field station through the first prediction model. More detailed descriptions regarding the first prediction model may be found in FIG. 3 and related descriptions thereof.

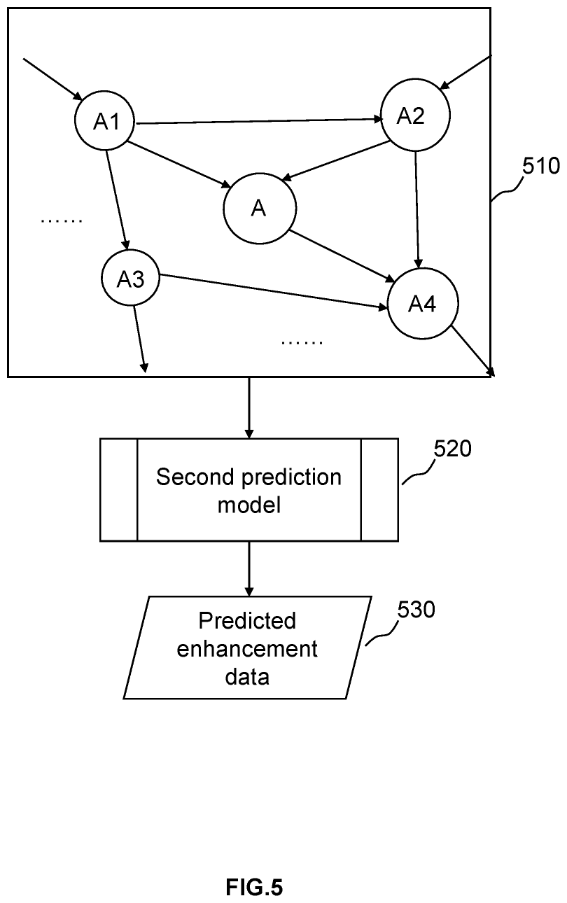

In some embodiments, the smart gas safety management platform may determine the predicted enhancement data based on a second prediction model. More descriptions may be found in FIG. 5 and the related descriptions thereof.

In some embodiments, the smart gas safety management platform may determine whether noise at the gas field station exceeds a noise limit based on the predicted enhancement data of the target field station and the associated field station, thereby determining the evaluation data. For example, if the noise at each gas field station does not exceed the noise limit, the higher the evaluation score; if the noise at any gas field station exceeds the noise limit, the more gas field stations exceed the noise limit, the lower the evaluation score.

In some embodiments of the present disclosure, by determining the predicted enhancement data for the target field station and the associated field station based on the candidate parameter, and determining the evaluation data of the candidate parameter based on the predicted enhancement data, it is possible to assess potential impacts of different candidate parameters on gas field stations, thereby better guiding the subsequent iteration of the candidate parameters, and facilitating the faster determination of the noise reduction control parameters.

In some embodiments, the smart gas safety management platform may determine the noise reduction control parameters through an iteration based on evaluation data of the candidate parameter. The noise reduction control parameters may be determined based on whether the iteration satisfies termination conditions. For example, the iteration termination condition may be that the evaluation data of the candidate parameters is greater than an evaluation threshold, etc. If the evaluation data of the candidate parameter in the current round of iteration is greater than the evaluation threshold, the smart gas safety management platform may identify a candidate pressure regulation update parameter of the candidate parameter in a current round of iteration as the pressure regulation update parameter of the target field station and/or the associated field station in the noise reduction control parameter for at least one future period. The evaluation threshold may be determined based on a priori knowledge. If the evaluation data of the candidate parameter in the current round of iteration is less than the evaluation threshold, the smart gas safety management platform may re-determine the candidate parameter for the next round and continue the iteration until the iteration meets the termination conditions, stop the iteration, and determine the noise reduction control parameters. The re-determination may randomly adjust the pressure regulation parameter of a specified count of associated field stations in the candidate parameter in a random direction according to a preset update rate to obtain an updated candidate parameter. For example, if the preset update rate is 5% and the specified count is 3, the smart gas safety management platform may randomly select 3 associated field stations and increase or decrease the pressure regulation parameter thereof by 5% to obtain the updated candidate parameter.

In some embodiments of the present disclosure, the adjustment amplitude of the pressure regulation parameter may be determined based on the noise enhancement data, and the pressure regulation parameter may be adjusted based on the adjustment amplitude to determine the candidate parameter. Then, the noise reduction control parameter may be determined based on the evaluation data of the candidate parameter by iteration, which enables dynamic adjustment and optimization of the pressure regulation parameter to better adapt to changes in noise, thereby improving the accuracy and efficiency of noise reduction control.

FIG. 5 is an exemplary schematic diagram illustrating determining predicted enhancement data through a second prediction model according to some embodiments of the present disclosure.

In some embodiments, the smart gas safety management platform may construct a field station regulation graph 510 and determine predicted enhancement data 530 based on the field station regulation graph 510 by the second prediction model 520. More detailed descriptions regarding the predicted enhancement data may be found in FIG. 4 and related descriptions thereof.

The field station regulator graph 510 refers to a graph that may characterize a regulation process at a target field station and an associated field station. The field station regulator graph may be a data structure composed of nodes and edges, where the edges connect the nodes. The nodes and edges may have features.

In some embodiments, the smart gas safety management platform may construct the field station regulation graph 510 based on candidate parameters, operational data, pressure regulation load data, noise limits, environmental features, at least one future period of a period to be predicted, at least one interest point, or the like, of the target field station and/or the associated field station. The second prediction model 520 may process the field station regulation graph 510 to determine predicted enhancement data 530. More detailed descriptions regarding the candidate parameters may be found in FIG. 4 and related descriptions thereof. More detailed descriptions regarding the future period may be found in FIG. 2 and related descriptions thereof.

The environmental features may include attributes related to the environment. For example, the environmental features may include ambient temperature, ambient humidity, or the like. In some embodiments, the smart gas safety management platform may obtain the environmental features from temperature sensors and humidity sensors configured by the smart gas pipeline network equipment object platform based on the smart gas pipeline network equipment sensing network platform. More descriptions regarding the operating data, the pressure regulation load data, and the noise limits may be found in FIG. 2 and related descriptions thereof. More detailed descriptions regarding the points of concern may be found in FIG. 3 and related descriptions thereof.

In some embodiments, the nodes of the field station regulation graph 510 may correspond to the target field station and associated field station. The node features may reflect relevant features of a corresponding field station. For example, the node features may include parameters involved in constructing the field station regulation graph.

In some embodiments, the edges of the field station regulation graph 510 may correspond to gas pipelines. In some embodiments, the edges are directed edges, and directions of the edges may be determined based on gas transmission directions. For example, the directions of the edges may be the gas transmission direction. The edge features may reflect the relevant features of the corresponding gas pipeline. In some embodiments, the edge features may include pipe length, pipe diameter, or the like.

In some embodiments, the field station regulation graph 510 includes at least one field station sub-graph of the target field station. The smart gas safety management platform may replace the nodes represented by the corresponding stations in the field station regulation graph 510 with the field station sub-graph of the target field station based on the field station regulation graph 510 adjusted by the field station sub-graph of the target field station.

Merely by way of example, in the field station regulation graph 510 of FIG. 5, A is a target field station, and A1, A2, A3, and A4 are associated field stations. A-1, A-2, A-3, and A-4 in the field station sub-graph of the target field station shown in FIG. 3 are pressure regulation devices included in the target field station node A, and B-1 and B-2 are interest points included in the target field station node A. The smart gas safety management platform may replace the node A in FIG. 5 with the field station sub-graph of the target field station in FIG. 3.

In some embodiments, at least one field station sub-graph of the target field station is constructed based on at least one pressure regulation device, a pipeline connected to the at least one pressure regulation device, and an interest point within the target field station and/or the associated field station. More descriptions regarding the field station sub-graph of the target field station may be found in FIG. 3 and related descriptions thereof.

In some embodiments of the present disclosure, the field station regulation graph may include at least one field station sub-graph of the target field station, which on the one hand may reflect the superposition of the noise between a plurality of pressure regulation devices and a plurality of points of concern, and on the other hand may supplement the noise data due to the gas transmission in the pipeline, allowing for the predicted enhancement data for at least one future period to be more complete and accurate.

In some embodiments, the second prediction model 520 may be a Graph Neural Network (GNN) model. In some embodiments, an input of the second prediction model 520 may be the field station regulation graph 510, and an output of the second prediction model 520 may be the predicted enhancement data 530 of the target field station and the associated field station for at least one future period, where outputs of nodes in the second prediction model correspond to the predicted enhancement data 530 of the corresponding field station for the at least one future period. In some embodiments, the input of the second prediction model 520 may be an adjusted field station regulation graph 510 based on a field station sub-graph, and the output may be the predicted enhancement data 530 of the target field station, the associated field station, and the interest point for at least one future period. The nodes in the second prediction model may output the predicted enhancement data 530 of corresponding field station for at least one future period.

The second prediction model may be trained based on second training samples with second labels. A plurality of second training samples with the second labels may be input into an initial second prediction model. A loss function may be constructed based on the second labels and results of the initial second prediction model, and parameters of the initial second prediction model may be iteratively updated based on the loss function. When the loss function of the initial second prediction model satisfies preconditions, the model training is completed and the trained second prediction model is obtained. The preconditions may be that the loss function converges, a count of iterations reaches a threshold, etc.

In some embodiments, the second training samples may be historical field station regulation graphs constructed based on historical data for a third period, and the second labels may be the actual noise enhancement data detected at the gas field station in the historical data for a fourth period. The third period may be earlier than the fourth period, and the fourth period may be the future period of the third period. In some embodiments, the second training samples may be obtained based on historical data. The second labels of the second training samples may be obtained through manual labeling.

When the field station regulation graph includes at least one field station sub-graph of the target field station, the second training sample may include a historical field station regulation graph, a historical field station sub-graph of the target field station, and historical interest points constructed based on historical data from the third period. The second labels may be noise enhancement data detected at the gas field station and at least one interest point in the historical data for the fourth period.

The method described in some embodiments of the present disclosure considers the gas flow between gas field stations and gas pipelines, as well as the interactions among gas field stations when determining the predicted enhancement data for at least one future period of the gas field stations. Therefore, the predicted enhancement data of each gas field station for at least one future period may be more realistic, thereby improving the accuracy of the predicted enhancement data.

Some embodiments of the present disclosure provide a non-transitory computer-readable storage medium storing computer instructions that, when executed by a computer, implement the smart gas field station noise reduction method described in any of the embodiments of the present disclosure.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and modifications are intended to be suggested by this disclosure and are within the spirit and scope of the exemplary embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the invention. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for noise reduction at a smart gas field station, wherein the method comprises:
obtaining relevant data of a target field station, wherein the relevant data comprises at least one of operating data of the target field station, noise data of the target field station, and a pressure regulation parameter of an associated field station, and the associated field station is a gas field station in a gas pipeline network that jointly regulates pressure with the target field station;
predicting, based on the relevant data, noise enhancement data of the target field station for at least one future period; and
determining, in response to the noise enhancement data satisfying a predetermined condition, a noise reduction control parameter based on the noise enhancement data and the pressure regulation parameter, wherein the noise reduction control parameter comprises at least a pressure regulation update parameter of the target field station or the associated field station for the at least one future period.

2. The method of claim 1, wherein the predicting, based on the relevant data, noise enhancement data of the target field station for at least one future period comprises:
determining, based on the pressure regulation parameter, pressure regulation load data of the target field station for the at least one future period; and
predicting, based on the relevant data and the pressure regulation load data, the noise enhancement data.

3. The method of claim 2, wherein the determining, based on the pressure regulation parameter, pressure regulation load data of the target field station for the at least one future period comprises:
assessing a usage impact value of gas usage on gas pressure based on gas usage data of upstream and downstream of the target field station;
determining a pre-regulation pressure and a target pressure of the target field station based on the usage impact value and the pressure regulation parameter; and
determining the pressure regulation load data based on the pre-regulation pressure and the target pressure.

4. The method of claim 2, wherein the method further comprises:
predicting the noise enhancement data by a first prediction model based on a field station sub-graph of the target field station, the first prediction model being a machine learning model.

5. The method of claim 1, wherein the determining, in response to the noise enhancement data satisfying a predetermined condition, a noise reduction control parameter based on the noise enhancement data and the pressure regulation parameter comprises:
determining an adjustment amplitude of the pressure regulation parameter based on the noise enhancement data;
determining a candidate parameter by adjusting the pressure regulation parameter based on the adjustment amplitude; and
determining the noise reduction control parameter through an iteration based on evaluation data of the candidate parameter.

6. The method of claim 5, wherein the determining an adjustment amplitude of the pressure regulation parameter based on the noise enhancement data comprises:
determining the adjustment amplitude based on a noise tolerance and associated enhancement data of the associated field station, wherein the noise tolerance is determined based on population distribution information around the associated field station and weather information of a day.

7. The method of claim 5, wherein determining the evaluation data of the candidate parameter comprises:
determining predicted enhancement data of the target field station and the associated field station based on the candidate parameter; and
determining the evaluation data of the candidate parameter based on the predicted enhancement data.

8. The method of claim 7, wherein the determining predicted enhancement data of the target field station and the associated field station based on the candidate parameters comprises:
constructing a field station regulation graph; and
determining the predicted enhancement data by a second prediction model based on the field station regulation graph, wherein the second prediction model is a machine learning model.

9. The method of claim 8, wherein the field station regulation graph comprises at least one field station sub-graph, the at least one field station sub-graph is constructed based on at least one pressure regulation device and a pipeline connected to the at least one pressure regulation device within the target field station or the associated field station.

10. An Internet of Things (IoT) system for noise reduction at a smart gas field station, wherein the system comprises a smart gas user platform, a smart gas service platform, a smart gas safety management platform, a smart gas pipeline network equipment sensing network platform, and a smart gas pipeline network equipment object platform;
the smart gas safety management platform includes a smart gas pipeline network safety management sub-platform and a smart gas data center;
the smart gas pipeline network equipment sensing network platform is configured to interact with the smart gas data center and the smart gas pipeline network equipment object platform;
the smart gas safety management platform is configured to:
obtain relevant data of a target field station, wherein the relevant data includes at least one of operating data of the target field station, noise data of the target field station, and pressure regulation parameter of an associated field station, and the associated field station is a gas field station in a gas pipeline network that jointly regulates pressure with the target field station;
predict, based on the relevant data, noise enhancement data of the target field station for at least one future time period;
determine, in response to the noise enhancement data satisfying a predetermined condition, a noise reduction control parameter based on the noise enhancement data and the pressure regulation parameter, wherein the noise reduction control parameter includes at least a pressure regulation update parameter of the target field station or the associated field station for the at least one future period; and
the smart gas service platform is configured to send the noise reduction control parameter to the smart gas user platform.

11. The system of claim 10, wherein the smart gas safety management platform is further configured to:
determine, based on the pressure regulation parameter, pressure regulation load data for the target field station for the at least one future period; and
predict the noise enhancement data based on the relevant data and the pressure regulation load data.

12. The system of claim 11, wherein the smart gas safety management platform is further configured to:
assess a usage impact value of gas usage on gas pressure based on gas usage data of upstream and downstream of the target field station;
determine a pre-regulation pressure and a target pressure of the target field station based on the usage and the pressure regulation parameter; and
determine the pressure regulation load data based on the pre-regulation pressure and the target pressure.

13. The system of claim 11, wherein the smart gas safety management platform is further configured to:
predict the noise enhancement data by a first prediction model based on a field station sub-graph of the target field station, wherein the first prediction model is a machine learning model.

14. The system of claim 10, wherein the smart gas safety management platform is further configured to:
determine an adjustment amplitude of the pressure regulation parameter based on the noise enhancement data;
determine a candidate parameter by adjusting the pressure regulation parameter based on the adjustment amplitude; and
determine the noise reduction control parameter by an iteration based on evaluation data of the candidate parameter.

15. The system of claim 14, wherein the smart gas safety management platform is further configured to:
determine the adjustment amplitude based on a noise tolerance and associated enhancement data of the associated field station, wherein the noise tolerance is determined based on population distribution information around the associated field station and weather information of a day.

16. The system of claim 14, wherein the smart gas safety management platform is further configured to:
determine predicted enhancement data of the target field station and the associated field station based on the candidate parameter; and
determine the evaluation data of the candidate parameter based on the predicted enhancement data.

17. The system of claim 16, wherein the smart gas safety management platform is further configured to:
construct a field station regulation graph; and
determine the predicted enhancement data by a second prediction model based on the field station regulation graph, wherein the second prediction model is a machine learning model.

18. The system of claim 17, wherein the field station regulation graph comprises at least one field station sub-graph, the at least one field station sub-graph is constructed based on at least one pressure regulation device and a pipeline connected to the at least one pressure regulation device within the target field station or the associated field station.

19. A non-transitory computer-readable storage medium storing computer instructions, wherein when reading the computer instructions in the storage medium, a computer implements the method of claim 1.
